(19) United States
(12) Patent Application Publication
(10) Pub. No.: US 2021/0289772 A1
(43) Pub. Date: Sep. 23, 2021

(54) WATER-SOLUBLE CONTROLLED RELEASE COMPOSITION AND METHODS FOR MAKING AND USING THE SAME

(71) Applicant: Hydroemission Corporation Pte Ltd, Singapore (SG)

(72) Inventor: Yi Xin Chew, Singapore (SG)

(73) Assignee: Hydroemission Corporation Pte Ltd, Singapore (SG)

(21) Appl. No.: 16/331,419

(22) PCT Filed: Sep. 8, 2017
(86) PCT No.: PCT/SG2017/050451

§ 371 Date: Mar. 7, 2019

(30) Foreign Application Priority Data
Sep. 8, 2016 (SG) 10201607476S

(51) Int. Cl. A01N 25/10; A01N 25/12; A01N 49/00; A01N 61/00; A01N 25/24; A01N 25/30; C05G 3/40; C05G 3/60; C05G 5/40

(52) U.S. Cl. CPC A01N 25/10; A01N 25/12; A01N 49/00; A01N 61/00; C05G 5/40; A01N 25/30; C05G 3/44; C05G 3/60; A01N 25/24

(57) ABSTRACT

The present invention relates generally to a water-soluble controlled release composition for eradication or control of insects and/or vegetation in a body of water, comprising: a water-soluble polymer acting as a matrix composition which can float in water; at least one active ingredient for eradicating or controlling a targeted insect and/or vegetation, the release of the active ingredient is regulated by the gradual dissolution of the composition; a surfactant; and a binder in an amount suitable to allow for blending of the above ingredients into a matrix composition. The invention also provides methods for making the composition and using the composition.

### FIELD OF INVENTION

This invention relates generally to a water-soluble controlled release composition for eradication or control of insects and/or vegetation, and more particularly, to a polymer matrix composition which can float in water, is fully water soluble (over a period of time) and contains active ingredients within the polymer matrix that are subsequently released into an aqueous environment for the continuous eradication and control of animals, insects and vegetation thriving at water surfaces via gradual dissolution of the composition for a period of time, such as at least 30 days. The invention also relates to a method for making the composition and a method for using the composition.

### BACKGROUND

The listing or discussion of a prior-published document in this specification should not necessarily be taken as an acknowledgement that the document is part of the state of the art or is common general knowledge.

Different species of unwanted insects (e.g. mosquito, mosquito larvae) and vegetation are found to thrive at water surfaces. Over the years, considerable effort has been expended seeking ways in which to control unwanted insect and vegetation populations. As such, effective pest and/or vegetation control products that can provide an extended release of a pest and/or vegetation control composition are desirable.

WO 2002/087342A1 teaches a floating sustained release pesticide granule for controlling a population of insects in an aquatic environment. This composition contains an active ingredient suspended in a water soluble sunscreen agent, and a flotation agent, said active ingredient, sunscreen agent and flotation agent are embedded in an insoluble fibrous matrix. When the granule is in contact with water, said water soluble sunscreen agent dissolves over time thereby releasing the active ingredient into the water in a sustained release manner. The granule is not entirely water soluble due to the presence of the insoluble fibrous matrix. This can create pollution issues, such as causing the blockage of water drainage systems.

U.S. Pat. No. 4,401,456 discloses a process for the preparation of alginate gel beads that contain bioactive materials dispersed therein and are useful in providing the controlled release of bioactive materials. The beads are based on alginate gel, so the types of active ingredients that can be incorporated are limited, because the gelation of alginate is sensitive to pH. Also the beads are not water-soluble, so a residue from the beads is left behind after the treatment has been completed. As such, use of these beads would result in pollution issues and the blockage of water drainage systems.

The international patent application published as WO 2010/014952 discloses a dual-release solid composition comprising a cap composition containing at least one active agent and a plaster; a base composition containing at least one active agent and a plaster; wherein the cap composition provides a quick release of the active agent over a period of less than 10 minutes and the base composition provides an extended release of the active agent over a period of at least 30 days when placed in water. The extended release of the active agent in the base composition is achieved by varying the amount of a water insoluble binder in the composition. The resulting composition cannot effectively float and is not entirely water soluble. Again, this can create pollution issues, leading to the blockage of water drainage systems. Moreover, the process for the preparation of the composition of this patent application requires compaction at elevated temperatures and with high forces sufficient to make all the ingredients adhere together to form a tablet. Hence no liquid-active ingredient or a small percentage of liquid active ingredients can be incorporated into the composition, because any liquids would be squeezed out under high pressure, and heat sensitive active ingredients, such as many anti-microbial active ingredients, cannot be used.

Other pest control products are described in, for example, U.S. Pat. Nos. 7,563,453, 7,837,988, 7,892,571, and 8,343,524. These products may attain their respective purposes, but they are not completely water soluble and/or cannot incorporate heat sensitive active ingredients or liquid ingredients. As such, these products all suffer either from the generation of pollution (e.g. blockage issues), and/or a limited selection of active ingredients.

Therefore, there is a need for a new composition for eradicating or controlling insects and/or vegetation which can solve the previously described drawbacks and which can be prepared in a simple and economic manner. Thus, the current invention entails providing a simple, cost-effective and fully water-soluble composition without causing any pollution problems.

### SUMMARY OF INVENTION

The present invention has been developed to fulfill the needs noted above and therefore has a principle object of the provision of a controlled release composition for eradicating or controlling insects and/or vegetation, while floating in water and being fully water-soluble. There is no residue left behind after the composition is consumed, and the composition does not cause any pollution issues or lead to the blockage of water flow paths.

Another object of the invention is to provide a controlled release composition for eradicating or controlling insects and/or vegetation which may be prepared at room temperature and at low pressure, allowing incorporation of various kinds of active ingredients including the heat-sensitive ones and liquid ingredients.

Thus, in a first aspect of the invention, there is provided a buoyant water-soluble controlled release composition for eradicating or controlling insects and/or vegetation in a body of water, comprising:
a water-soluble polymer;
at least one active agent;
at least one surfactant; and
a binder, wherein
the binder comprises at least one hydroxyl moiety.

In an embodiment of the first aspect of the invention:
the water-soluble polymer may be present in an amount of from 35.0 to 60.0 wt % (e.g. from 45.0 to 60.0 wt %);
the at least one active agent may be present in an amount of from 0.1 to 50.0 wt % (e.g. from 0.1 to 40.0 wt %, such as from 0.1 to 35.5 wt %, such as from 0.1 to 25.0 wt %, from 0.1 to 15.0 wt % or from 0.3 to 10 wt %);
the at least one surfactant may be present in an amount of from 5.0 to 35.0 wt % (e.g. from 6.0 to 30 wt %); and
the binder may be present in an amount of from 10.0 to 50.0 wt % (e.g. from 10.0 to 40 wt %).

For example, the water-soluble polymer may be present in an amount of from 38.0 to 59.5 wt % (e.g. from 45.0 to 59.5 wt %, such as from 49.0 to 59.5 wt %); the at least one active agent may be present in an amount of from 6.0 to 15.0 wt % (e.g. from 6.0 to 9.5 wt %); the at least one surfactant may be present in an amount of from 7.5 to 22.0 wt %; and the binder may be present in an amount of from 22.7 to 40.0 wt % (e.g. from 22.7 to 30.0 wt %), or alternatively: the water-soluble polymer may be present in an amount of from 38.0 to 59.5 wt % (e.g. from 45.0 to 59.5 wt %, such as from 49.0 to 59.5 wt %); the at least one active agent may be present in an amount of from 0.3 to 2.5 wt % (e.g. from 0.4 to 2.0 wt %); the at least one surfactant may be present in an amount of from 7.5 to 22.0 wt %; and the binder may be present in an amount of from 22.7 to 40.0 wt % (e.g. from 22.7 to 30.0 wt %). In further alternative embodiments, the water-soluble polymer may be present in an amount of from 35.0 to 45.2 wt %; the at least one active agent may be present in an amount of from 1.0 to 25.0 wt %; the at least one surfactant may be present in an amount of from 10 to 22.0 wt %; and the binder may be present in an amount of from 22.7 to 30.0 wt % (e.g. from 22.7 to 25.1 wt %).

In embodiments of the invention, the water-soluble polymer may be selected from one or more of the group consisting of polyvinyl alcohol, polyethylene glycols, carrageenan lambda, hyaluronic acid, pullulan, polyvinylpyrrolidone, polyacrylic acid, gum acaia, gelatin, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, tragacanth, guar gum, polyacrylamide, and poly(2-ethyl-2-oxazoline), salts thereof and copolymers thereof (e.g. the water-soluble polymer may be selected from one or more of the group consisting of polyvinylpyrrolidone, polyvinyl alcohol, polyacrylic acid, polyethylene glycols, carboxymethylcellulose, microcrystalline cellulose, hydroxypropylmethylcellulose, ethylcellulose, and methylcellulose and copolymers thereof).

In certain embodiments of the invention that may be mentioned herein, the water-soluble polymer may comprise at least two polymers, where:
a first of the at least two polymers may be selected from the group consisting of carrageenan lambda, hyaluronic acid, dextrans, pullulan, polyvinylpyrrolidone, polyvinyl alcohol, polyacrylic acid, polyethylene glycols, salts thereof and copolymers thereof;
a second of the at least two polymers may be selected from the group consisting of gum acaia, gelatin, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, and salts thereof (e.g. the first polymer may be selected from the group consisting of polyvinylpyrrolidone, polyvinyl alcohol, polyacrylic acid, polyethylene glycols, and copolymers thereof; and the second polymer may be selected from the group consisting of carboxymethylcellulose, microcrystalline cellulose, hydroxypropylmethylcellulose, ethylcellulose, and methylcellulose (e.g. the first polymer may be polyvinylalcohol and the second water-soluble polymer may be hydroxypropylmethylcellulose)). In embodiments where there are two polymers, when the total amount of polymer is taken as being 100 wt % by weight, the first polymer may be present in an amount of from 40.0 wt % to 95.0 wt % and the second polymer may be present in an amount of from 5.0 wt % to 60.0 wt % (e.g. the first polymer may be present in an amount of from 41.0 wt % to 90.0 wt % and the second polymer may be present in an amount of from 10.0 wt % to 59.0 wt %, such as where the first polymer may be present in an amount of from 65.0 wt % to 90.0 wt % and the second polymer may be present in an amount of from 10.0 wt % to 35.0 wt %).

In certain embodiments of the invention, the composition may further comprise a crosslinking agent, optionally wherein the crosslinking agent is present in an amount of from 0.1 to 10.0 wt % (e.g. from 0.4 to 5.0 wt %). The crosslinking agent may be selected from one or more of the group consisting of sodium tetraborate, ammonium zirconium carbonate, sodium borate dialdehyde, melamine-formaldehyde, urea-formaldehyde, polyamide-epichlorohydrin, dimethylolurea, a polyfunctional azirdine, methoxymethylmelamine, a melamine-formaldehyde resin prepolymer, a urea-formaldehyde resin prepolymer, calcium salts, and barium salts (e.g. one or more of the group consisting of sodium tetraborate, ammonium zirconium carbonate, and sodium borate dialdehyde). When crosslinking agent is present, it may be present in an amount of from 0.3 to 6.0 wt % (e.g. from 0.4 to 4.6 wt %, such as from 0.8 to 4.0 wt %).

As noted above, in certain embodiments of the invention the water-soluble polymer may be at least two polymers. In such embodiments of the invention, when a crosslinking agent is present it may be a crosslinking agent for one of the at least two polymers. For example, one of the polymers may be polyvinyl alcohol and the crosslinking agent may be sodium tetraborate and/or ammonium zirconium carbonate.

In certain embodiments, the at least one active agent may be selected from one or more of the group consisting of biocides, insect pheromones, juvenile hormones, fertilizers, seed germination stimulants, and plant growth regulators. In certain embodiments, the at least one active agent may be a biocide, optionally wherein the biocide may be a pesticide (e.g. the pesticide may be selected from one or more of the group consisting of herbicides, insecticides, insect growth regulators, nematicides, termiticides, molluscicides, piscicides, avicides, rodenticides, predacides, bactericides, microbicide, spermicides, algicides, nematicides, molluscicides, schistosomacides, larvicides, adulticides, insect repellents, animal repellents, antimicrobials, fungicides, disinfectants (antimicrobial), and sanitizers). For example, the at least one active agent may be one or more selected from the group consisting of Bacillus thuringiensis serotype israelensis, O,O,O′,O′-tetramethyl-O,O′-sulfanediylbis(1,4-phenylene) diphosphorothioate, and alkyldimethylbenzylammonium chlorides. In certain embodiments, the at least one active agent may be present in an amount of from 0.5 to 1.5 wt %. In alternative embodiments, the at least one active agent may be present in an amount of from 7.5 to 9.3 wt %.

In yet further embodiments of the invention, the binder may be selected from one or more of the group consisting of an mono-alkoxyalcohol, or more particularly, a dialkoxyalcohol, a trialkoxyalcohol, a poly-alkoxyalcohol and water. For example, the binder may be ethanol and/or glycerol and/or water. The binder may be present in an amount of from 22.0 to 30.0 wt %.

In embodiments of the invention, the surfactant may be an amphoteric or, more particularly, an ionic and/or non-ionic surfactant. The surfactant may be a silicon surfactant and/or a fluorosurfactant and/or a polymeric surfactant.

For example, when the surfactant is (or comprises) a non-ionic surfactant the non-ionic surfactant may be selected from one or more of the group consisting of ethoxylated linear alcohols, ethoxylated alkyl phenols, fatty acid esters, fatty alcohol polyglycosides, alkylpolyglucosides ethleneoxide/propyleneoxide copolymers, polyalcohols, ethoxylated polyalcohols, thiols (mercaptans), amides and alkylpolyglucosides.

In alternative or additional embodiments, when the surfactant is (or comprises) an ionic surfactant, the ionic surfactant may be a cationic surfactant (e.g. the cationic surfactant is an ammonium-containing surfactant, which may be selected from one or more of the group containing dodecylamine acetate, dodecylamine hydrochloride, dodecyltrimethylammonium hydrochloride, benzalkonium chloride, and cetrimonium bromide).

In certain embodiments of the invention, when the active agent comprises an enzyme or a microorganism (e.g. a bacteria), the surfactant is an anionic, amphoteric, or more particularly a non-ionic surfactant. Without wishing to be bound by theory, it is believed that many cationic surfactants may have a degree of biocidal activity, making them unsuitable for use with such active agents. In particular embodiments using such agents, the surfactant may be exclusively composed of non-ionic surfactants.

In embodiments of the invention, the composition may further comprise one or more additives or excipients. For example, the additives or excipients may be one or more of:
(a) a mineral oil, optionally in an amount of from 0.5 to 5 wt % (e.g. from 1.0 to 2 wt %); and/or
(b) a colorant (e.g. a yellow dye), optionally in an amount of from 0.05 to 0.5 wt % (e.g. from 0.1 to 0.2 wt %); and/or
(c) a preservative (e.g. citric acid);
(d) a sunscreen agent; and/or
(e) a buffer agent (e.g. citric acid).

In yet still further embodiments of the invention, the composition may be provided in the form of tablets, pellets, blocks, cylinders, or granulated particles.

As noted above, it is an objective of the current invention to provide a sustained-release composition that can float for an extended period of time, so as to deliver the active agent in a sustained manner to the required area. Thus, in embodiments of the invention, the composition may be provided in a form that the composition fully dissolves into a body of water over a period of from 2 days to 100 days (e.g. from 10 days to 50 days, such as from 30 days to 40 days). In certain embodiments that may be mentioned herein, the composition may further comprise pockets of a gas (e.g. air) within the composition.

Any technically sensible combination of the above embodiments explicitly falls within the scope of the current invention.

In a second aspect of the invention, there is provided a method of preparing a buoyant water-soluble controlled release composition for eradicating or controlling insects and/or vegetation in a body of water according to the first aspect of the invention and any technically sensible combination of its embodiments, wherein the method comprises the steps of:
(a) providing a blended mixture comprising:
   a water-soluble polymer;
   at least one active agent;
   at least one surfactant; and
   a binder; and
(b) extruding the blended mixture to form an extrudate.

In embodiments of the process, the process may further comprise:
(c) subjecting the extrudate of step (b) to from one to five further rounds of extrusion.

In a third aspect of the invention, there is provided a use of a composition according to the first aspect of the invention (or any technically sensible combination of it and its embodiments) to eradicate or control insects and/or vegetation in an aqueous environment.

In a fourth aspect of the invention, there is provided a method of eradicating or controlling insects and/or vegetation in a body of water, comprising placing the water-soluble controlled release composition according to the first aspect of the invention (or any technically sensible combination of it and its embodiments) into the body of water.

The composition of the invention is easy to apply, safe to handle, does not require any dispensing equipment, does not require any electricity, and does not pollute the environment in which it is applied, by leaving behind residues after the treatment period.

Yet further aspects and embodiments of the invention may be found in the following numbered clauses.

1. A buoyant water-soluble controlled release composition for eradicating or controlling insects and/or vegetation in a body of water, comprising:
a water-soluble polymer;
at least one active agent;
at least one surfactant; and
a binder, wherein
the binder comprises at least one hydroxyl moiety.
   2. The composition according to Clause 1, wherein:
the water-soluble polymer is present in an amount of from 35.0 to 60.0 wt %;
the at least one active agent is present in an amount of from 0.1 to 50.0 wt % (e.g. from 0.1 to 40.0 wt %, such as from 0.1 to 35.5 wt %, such as from 0.1 to 25.0 wt %);
the at least one surfactant is present in an amount of from 5.0 to 35.0 wt %; and
the binder is present in an amount of from 10.0 to 50.0 wt %.
   3. The composition according to Clause 2, wherein:
the water-soluble polymer is present in an amount of from 38.0 to 59.5 wt % (e.g. from 45.0 to 59.5 wt %);
the at least one active agent is present in an amount of from 6.0 to 15.0 wt %;
the at least one surfactant is present in an amount of from 7.5 to 22.0 wt %;
the binder is present in an amount of from 22.7 to 40.0 wt %.
   4. The composition according to Clause 2, wherein:
the water-soluble polymer is present in an amount of from 38.0 to 59.5 wt % (e.g. from 45.0 to 59.5 wt %);
the at least one active agent is present in an amount of from 0.3 to 2.5 wt % (e.g. from 0.4 to 2.0 wt %);
the at least one surfactant is present in an amount of from 7.5 to 22.0 wt %;
the binder is present in an amount of from 22.7 to 40.0 wt %.
   5. The composition according to Clause 2, wherein:
the water-soluble polymer is present in an amount of from 35.0 to 45.2 wt %;
the at least one active agent is present in an amount of from 1.0 to 25.0 wt %, such as from 1.0 to 1.5 wt %;
the at least one surfactant is present in an amount of from 10.0 to 22.0 wt %; and
the binder is present in an amount of from 22.7 to 30.0 wt %, such as from 22.7 to 25.1 wt %.
   6. The composition according to any one of the preceding clauses, wherein the water-soluble polymer is selected from one or more of the group consisting of carrageenan lambda, hyaluronic acid, pullulan, polyvinylpyrrolidone, polyacrylic acid, gum acaia, p, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, tragacanth, guar gum, polyacrylamide, and poly(2-ethyl-2-oxazoline), salts thereof and copolymers thereof.
   7. The composition of Clause 5, wherein the polymer water-soluble polymer is selected from one or more of the group consisting of polyvinylpyrrolidone, polyvinyl alcohol, polyacrylic acid, polyethylene glycols, carboxymethylcellulose, microcrystalline cellulose, hydroxypropylmethylcellulose, ethylcellulose, and methylcellulose and copolymers thereof.
   8. The composition of Clause 7, wherein the polymer water-soluble polymer comprises at least two polymers, where:
a first of the at least two polymers is selected from the group consisting of carrageenan lambda, hyaluronic acid, dextrans, pullulan, polyvinylpyrrolidone, polyvinyl alcohol, polyacrylic acid, polyethylene glycols, salts thereof and copolymers thereof;
a second of the at least two polymers is selected from the group consisting of gum acaia, gelatin, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, and salts thereof.
   9. The composition of Clause 8, wherein:
the first polymer is selected from the group consisting of polyvinylpyrrolidone, polyvinyl alcohol, polyacrylic acid, polyethylene glycols, and copolymers thereof; and
the second polymer is selected from the group consisting of carboxymethylcellulose, microcrystalline cellulose, hydroxypropylmethylcellulose, ethylcellulose, and methylcellulose.
   10. The composition of Clause 8 or Clause 9, wherein, when the total amount of polymer is taken as being 100 wt % by weight, the first polymer is present in an amount of from 40.0 wt % to 95.0 wt % and the second polymer is present in an amount of from 5.0 wt % to 60.0 wt % (e.g. the first polymer is present in an amount of from 41.0 wt % to 90.0 wt % and the second polymer is present in an amount of from 10.0 wt % to 59.0 wt %, such as where the first polymer is present in an amount of from 65.0 wt % to 90.0 wt % and the second polymer is present in an amount of from 10.0 wt % to 35.0 wt %).
   11. The composition according to any one of the preceding clauses, wherein the composition further comprises a crosslinking agent, optionally wherein the crosslinking agent is present in an amount of from 0.1 to 10.0 wt % (e.g. from 0.4 to 5.0 wt %).
   12. The composition according to any one of the preceding clauses, wherein the crosslinking agent is selected from one or more of the group consisting of sodium tetraborate, ammonium zirconium carbonate, sodium borate dialdehyde, melamine-formaldehyde, urea-formaldehyde, polyamide-epichlorohydrin, dimethylolurea, a polyfunctional azirdine, methoxymethylmelamine, a melamine-formaldehyde resin prepolymer, a urea-formaldehyde resin prepolymer, calcium salts, and barium salts.
   13. The composition according to Clause 12, wherein, the crosslinking agent is selected from one or more of the group consisting of sodium tetraborate, ammonium zirconium carbonate, and sodium borate dialdehyde.
   14. The composition according to any one of Clauses 8 to 10 and Clauses 11 to 13 as dependent thereupon, wherein the crosslinking agent is a crosslinking agent for the first of the at least two polymers.
   15. The composition according to Clause 14, wherein the first polymer is polyvinyl alcohol and the crosslinking agent is sodium tetraborate and/or ammonium zirconium carbonate.
   16. The composition according to any one of Clause 12 to 15, wherein the crosslinking agent is present in an amount of from 0.3 to 6.0 wt % (e.g. from 0.4 to 4.6 wt %, such as from 0.8 to 4.0 wt %).
   17. The composition according to any one of Clauses 1, 2, 4 and 6 to 15, wherein the at least one active agent is present in an amount of from 0.5 to 1.5 wt %.
   18. The composition according to any one of Clauses 1 to 3 and 6 to 15, wherein the at least one active agent is present in an amount of from 7.5 to 9.3 wt %.
   19. The composition according to any one of the preceding clauses, wherein, the at least one active agent is selected from one or more of the group consisting of biocides, insect pheromones, juvenile hormones, fertilizers, seed germination stimulants, and plant growth regulators.
   20. The composition according to Clause 19, wherein the at least one active agent is a biocide, optionally wherein the biocide is a pesticides (e.g. the pesticide is selected from one or more of the group consisting of herbicides, insecticides, insect growth regulators, nematicides, termiticides, molluscicides, piscicides, avicides, rodenticides, predacides, bactericides, microbicide, spermicides, algicides, nematicides, molluscicides, schistosomacides, larvicides, adulticides, insect repellents, animal repellents, antimicrobials, fungicides, disinfectants (antimicrobial), and sanitizers).
   21. The composition according to Clause 20, wherein the at least one active agent is one or more selected from the group consisting of Bacillus thuringiensis serotype israelensis, O,O,O′,O′-tetramethyl-O,O′-sulfanediylbis(1,4-phenylene) diphosphorothioate, and alkyldimethylbenzylammonium chlorides.
   22. The composition according to any one of the preceding clauses, wherein the binder is present in an amount of from 22.7 to 30.0 wt %.
   23. The composition according to any one of the preceding clauses, wherein the binder is selected from one or more of the group consisting of an mono-alkoxyalcohol, or more particularly, a dialkoxyalcohol, a trialkoxyalcohol, a poly-alkoxyalcohol and water.
   24. The composition according to Clause 23, wherein the binder is selected from one or more of the group consisting of glycerol, ethanol, water.
   25. The composition according to any one of the preceding clauses, wherein the surfactant is an ionic surfactant, an amphoteric surfactant, non-ionic surfactant or combinations thereof (e.g. an ionic and/or non-ionic surfactant), optionally wherein the surfactant is a silicon surfactant and/or a fluorosurfactant and/or a polymeric surfactant.
   26. The composition according to Clause 25, wherein the non-ionic surfactant is selected from one or more of the group consisting of ethoxylated linear alcohols, ethoxylated alkyl phenols, fatty acid esters, fatty alcohol polyglycosides, alkylpolyglucosides ethleneoxide/propyleneoxide copolymers, polyalcohols, ethoxylated polyalcohols, thiols (mercaptans), amides and alkylpolyglucosides.
   27. The composition according to Clause 25, wherein the ionic surfactant is a cationic surfactant.
   28. The composition of Clause 27, wherein the cationic surfactant is an ammonium-containing surfactant.
   29. The composition of Clause 27, wherein the ammonium-containing surfactant is selected from one or more of the group containing dodecylamine acetate, dodecylamine hydrochloride, dodecyltrimethylammonium hydrochloride, benzalkonium chloride, and cetrimonium bromide.
   30. The composition according to any one of the preceding clauses, wherein the composition further comprises one or more additives or excipients.
   31. The composition according to Clause 30, wherein the additive or excipient comprises:
(a) a release agent (e.g. a mineral oil), optionally in an amount of from 0.5 to 5 wt % (e.g. from 1.0 to 2 wt %); and/or
(b) a colorant (e.g. a yellow dye), optionally in an amount of from 0.05 to 0.5 wt % (e.g. from 0.1 to 0.2 wt %); and/or
(c) a preservative (e.g. citric acid);
(d) a sunscreen agent; and/or
(e) a buffer agent (e.g. citric acid).
   32. The composition according to any one of the preceding clauses, wherein:
(a) the composition is provided in the form of tablets, pellets, blocks, cylinders, or granulated particles; and/or
(b) the composition is provided in a form having a weight of from 10 g to 50 kg, such as from 20 g to 20 kg, such as 100 g to 5 kg.
   33. The composition according to any one of the preceding clauses, wherein the composition is provided in a form that the composition fully dissolves into a body of water over a period of from 2 days to 100 days (e.g. from 10 days to 50 days, such as from 30 days to 40 days).
   34. The composition according to any one of the preceding clauses, wherein the composition comprises pockets of a gas (e.g. air) within the composition.
   35. The composition according to any one of the preceding clauses, wherein the composition is buoyant for a period of at least 2 seconds, such as at least 10 seconds, such as at least 30 seconds, such as at least 1 minute, such as at least 10 minutes, such as at least 30 minutes, such as at least 1 hour or, more particularly, such as at least 4 hours following its placement into a body of water.
   36. A method of preparing a buoyant water-soluble controlled release composition for eradicating or controlling insects and/or vegetation in a body of water according to any one of Clauses 1 to 35, wherein the method comprises the steps of:
(a) providing a blended mixture comprising:
   a water-soluble polymer;
   at least one active agent;
   at least one surfactant; and
   a binder; and
(b) extruding the blended mixture to form an extrudate.
   37. The method of Clause 36, wherein the process further comprises:
(c) subjecting the extrudate of step (b) to from one to five further rounds of extrusion.
   38. Use of a composition according to any one of Clauses 1 to 35 to eradicate or control controlling insects and/or vegetation in an aqueous environment.
   39. A method of eradicating or controlling insects and/or vegetation in a body of water, comprising placing the water-soluble controlled release composition according to any one of Clauses 1 to 35 into the body of water.

### DESCRIPTION

While this invention is illustrated and described in preferred embodiments, the compositions of the invention may be produced in many different configurations, sizes, forms and materials.

As noted hereinbefore, the current invention relates to a buoyant water-soluble controlled release composition for eradicating or controlling insects and/or vegetation in a body of water, comprising:
a water-soluble polymer;
at least one active agent;
at least one surfactant; and
a binder, wherein
the binder comprises at least one hydroxyl moiety.

It has been surprisingly found that the above composition is capable of maintaining a sustained release of an active agent over an extended period of time in a body of water, while ensuring that the release of the active agent is controlled to provide maximum efficacy at the surface, or at a pre-determined depth, of the body of water. Thus, the current formulation ensures that the active agent is targeted to the correct portions of the body of water where it is needed and therefore reduces the amounts of active agent required. This reduces the costs associated with the product and also reduces the potential for unwanted toxicity in the aqueous environment. As will be appreciated, compositions of the current invention are not intended to be used on the human or animal body. For example, the compositions disclosed herein may be provided in a form having a weight of from 10 g to 50 kg, such as from 20 g to 20 kg, such as 100 g to 5 kg.

In particular embodiments of the invention that may be mentioned herein:
the water-soluble polymer is present in an amount of from 35.0 to 60.0 wt % (e.g. from 45.0 to 60.0 wt %);
the at least one active agent is present in an amount of from 0.1 to 50.0 wt % (e.g. from 0.1 to 40.0 wt %, such as from 0.1 to 35.5 wt %, such as from 0.1 to 25.0 wt %, from 0.1 to 15.0 wt % or from 0.3 to 10 wt %);
the at least one surfactant is present in an amount of from 5.0 to 35.0 wt % (e.g. from 6.0 to 30 wt %); and
the binder is present in an amount of from 10.0 to 50.0 wt % (e.g. from 10.0 to 40 wt %).

For the avoidance of doubt, unless otherwise stated the weight percentages provided herein relate to the actual weight percentage of the ingredients mentioned. In addition, the weight percentages listed herein may vary by around 0.1 or 0.2 wt %.

In certain embodiments of the invention mentioned directly hereinabove:
the water-soluble polymer is present in an amount of from 38.0 to 59.5 wt % (e.g. from 45.0 to 59.5 wt %, such as from 49.0 to 59.5 wt %);
the at least one active agent is present in an amount of from 6.0 to 15.0 wt % (e.g. from 6.0 to 9.5 wt %);
the at least one surfactant is present in an amount of from 7.5 to 22.0 wt % (e.g. from 11.0 to 22.0 wt %);
the binder is present in an amount of from 22.7 to 40.0 wt % (e.g. from 22.7 to 30.0 wt %).

These formulations may be particularly suitable for compositions where it is necessary to have a high proportion of active agent in the composition (e.g. when using a bacterial biocide).

In alternative embodiments of the invention mentioned directly hereinabove:
the water-soluble polymer is present in an amount of from 38.0.0 to 59.5 wt % (e.g. from 45.0 to 59.5 wt %, such as from 49.0 to 59.5 wt %);
the at least one active agent is present in an amount of from 0.3 to 2.5 wt % (e.g. from 0.4 to 2.0 wt %);
the at least one surfactant is present in an amount of from 7.5 to 22.0 wt %;
the binder is present in an amount of from 22.7 to 40.0 wt % (e.g. from 22.7 to 30.0 wt %).

These formulations may be particularly suitable for compositions where a small amount of active agent is necessary in order to provide the desired effect (e.g. a chemical product, rather than an organism).

In yet further alternative embodiments of the invention:
the water-soluble polymer is present in an amount of from 35.0 to 45.2 wt %;
the at least one active agent is present in an amount of from 1.0 to 25.0 wt %, such as from 1.0 to 1.5 wt %;
the at least one surfactant is present in an amount of from 10.0 to 22.0 wt %; and
the binder is present in an amount of from 22.7 to 30.0 wt %, such as from 22.7 to 25.1 wt %.

Such compositions may encompass compositions that are buoyant for at least 80% of the time until full dissolution or compositions that are designed to sink following an initial period of buoyancy (i.e. compositions which remain buoyant for less than 70% of the time until full dissolution, but which retain buoyancy for a minimum period before sinking, such as at least 2 seconds, such as at least 10 seconds, such as at least 30 seconds, such as at least 1 minute, such as at least 10 minutes, such as at least 30 minutes, such as at least 1 hour or, more particularly, such as at least 4 hours (e.g. at least 5 hours), such as at least 6 hours or at least 24 hours (e.g. from 24 to 336 hours).

It will be appreciated that the percentages provided above refer to minimal and maximal bounds and in the composition the values are intended to be selected to add up to 100%. However, it will also be appreciated that additional components and excipients or additives may also be present as discussed hereinbelow, each with their own percentage values. As can be seen, these additional components, excipients and additives may also be incorporated into the composition without exceeding 100%.

It will be appreciated that the composition may be presented as any suitable form for dosing the water body. For example, it may be presented as tablets, pellets, blocks, cylinders, or granulated particles (or combinations thereof, where it may be desired to mix forms of the composition together to provide tailored release profiles, such as providing granulated particles with blocks to enable an increased initial release of active agent provided by the higher surface area (and hence dissolution speed) granulated particles and a longer sustained release phase provided by one or more blocks of the composition).

When used herein, the term “controlled release” refers to release of an active agent(s) from the composition over an extended period of time, following contact with water. The extended period of time may refer to a period of from 5 days to 90 days, such as from 10 days to 60 days, for example from 15 days to 45 days (i.e. from 20 days to 30 days). It will be appreciated that the formulation is intended to retain its buoyancy over the extended period of time in order to continually deliver the active agent to its desired site of action.

When used herein, the term “buoyant” refers a composition that floats at a desired depth within a body of water. For example, while the term may exclusively refer to a composition that floats at the surface of a body of water in certain embodiments of the invention (i.e. at least part of the dosage form of the composition is at the surface of the water body), it may also refer to a composition that is capable of being fully submerged within the water body, but not in contact with the floor of the water body. In other words, the dosage forms of the composition of the current invention may be tailored to float at a desired depth in the body of water. It will also be appreciated that buoyant compositions disclosed herein may be buoyant until they fully dissolve, or may be buoyant at least for an initial time period. For example, the buoyant compositions may be buoyant for a period of at least 2 seconds, such as at least 10 seconds, such as at least 30 seconds, such as at least 1 minute, such as at least 10 minutes, such as at least 30 minutes, such as at least 1 hour or, more particularly, such as at least 4 hours (e.g. at least 5 hours), such as at least 6 hours or at least 24 hours (e.g. from 24 to 336 hours) before they sink to the bottom of the body of water into which they have been placed.

The polymer used in the invention is fully water-soluble. The water-soluble polymer may serve as a matrix structure for the composition and may assist in regulating the release of the active agent(s) over an extended period of time. Without wishing to be bound by theory, it is believed that the controlled slow dissolution of the polymer may help to control the dissolution release profile of the active agent(s). It will be appreciated that any water-soluble polymer with slow dissolution properties may be used herein, whether inherently, or by adaptation. Suitable water soluble polymers that may be mentioned herein include, but are not limited to, carrageenan lambda, hyaluronic acid, pullulan, polyvinylpyrrolidone, polyacrylic acid, gum acaia, gelatin, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, tragacanth, guar gum, polyacrylamide, and poly(2-ethyl-2-oxazoline), salts thereof, copolymers thereof and blends thereof. More particular polymers that may be mentioned in embodiments of the invention include one or more of those selected from the group consisting of carrageenan lambda, hyaluronic acid, pullulan, polyvinylpyrrolidone, polyacrylic acid, gum acaia, gelatin, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, tragacanth, guar gum, polyacrylamide, and poly(2-ethyl-2-oxazoline), salts thereof and copolymers thereof (e.g. one or more of the group consisting of polyvinylpyrrolidone, polyvinyl alcohol, polyacrylic acid, polyethylene glycols, carboxymethylcellulose, microcrystalline cellulose, hydroxypropylmethylcellulose, ethylcellulose, and methylcellulose.

The polymers used in the current invention may, in certain embodiments, have a viscosity of from 3 to 100 CPS. For example, when polyvinyl alcohol is used, the viscosity may be from 3 to 72 CPS (e.g. from 3 to 45 CPS, such as 5 to 30 CPS).

In certain embodiments of the invention, it may be useful to make use of two or more polymers within the composition. This may provide the composition with enhanced controlled-release properties and/or flotation enhancement. In embodiments of the invention where there are at least two water soluble polymers present in the composition, a first of the at least two polymers may be selected from the group consisting of carrageenan lambda, hyaluronic acid, dextrans, pullulan, polyvinylpyrrolidone, polyvinyl alcohol, polyacrylic acid, polyethylene glycols, salts thereof and copolymers thereof. In embodiments of the invention where there are at least two water soluble polymers present in the composition, a second of the at least two polymers may be selected from the group consisting of gum acaia, gelatin, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, and salts thereof. For the avoidance of doubt, when there are two polymers present in the composition, it is preferred that at least one polymer is provided from the list of first polymers and at least one polymer is provided from the list of second polymers. However, the composition may contain more than two (e.g. 3, 4, 5, 6 etc) polymers from each of the first and second polymer lists, provided that at least one polymer is provided from the corresponding polymer list (e.g. 2 first polymers and one second polymer). In particular embodiments of the invention that may be mentioned herein, the first polymer may be selected from the group consisting of polyvinylpyrrolidone, polyvinyl alcohol, polyacrylic acid, polyethylene glycols, and copolymers thereof, and the second polymer is selected from the group consisting of carboxymethylcellulose, microcrystalline cellulose, hydroxypropylmethylcellulose, ethylcellulose, and methylcellulose (e.g. the first polymer may be selected from the group consisting of polyvinylpyrrolidone, polyvinyl alcohol, polyacrylic acid, polyethylene glycols, and copolymers thereof, and the second water-soluble polymer is hydroxypropylmethylcellulose).

In embodiments of the invention where two or more polymers are present, when the total amount of polymer is taken as being 100 wt % by weight of the polymer (and not of the entire composition), polymers of the first polymer list may present in an amount of from 40.0 wt % to 95.0 wt % and polymers of the second polymer list may be present in an amount of from 5.0 wt % to 60.0 wt % (e.g. polymers of the first polymer list may be present in an amount of from 41.0 wt % to 90.0 wt % and the polymers of the second polymer list may be present in an amount of from 10.0 wt % to 59.0 wt %, such as where polymers of the first polymer list may be present in an amount of from 65.0 wt % to 90.0 wt % and polymers of the second polymer list may be present in an amount of from 10.0 wt % to 35.0 wt %).

In certain embodiments of the invention, the composition may further comprise a crosslinking agent that crosslinks the water soluble polymer. Without wishing to be bound by theory, the crosslinking agent may enhance the controlled release performance of the composition by attenuating the dissolution rate of the water soluble polymer, thereby affecting the dissolution profile of the polymer, which may in turn affect the release profile of the active agent(s). The crosslinking agent selected depends on the polymer(s) in the composition that it is desired to crosslink. Examples of crosslinking agents include, but are not limited to, sodium tetraborate, ammonium zirconium carbonate, sodium borate dialdehyde, melamine-formaldehyde, urea-formaldehyde, polyamide-epichlorohydrin, dimethylolurea, a polyfunctional azirdine, methoxymethylmelamine, a melamine-formaldehyde resin prepolymer, a urea-formaldehyde resin prepolymer, calcium salts, barium salts, and combinations thereof (e.g. sodium tetraborate, ammonium zirconium carbonate, sodium borate dialdehyde, and combinations thereof).

It will be appreciated that particular crosslinking agents may be more suitable for certain polymers than others. For example, a crosslinking agent for polyvinyl alcohol may be selected from, but not limited to, sodium tetraborate, ammonium zirconium carbonate, sodium borate dialdehyde, melamine-formaldehyde, urea-formaldehyde, polyamide-epichlorohydrin, inorganic salts, cyclic amide, organic titanates, and any combination thereof, preferably sodium tetraborate. A crosslinking agent for methylcellulose may be selected from, but not limited to, dimethylolurea, polyfunctional azirdines, stearatochromyl chloride complex, methoxymethylmelamine, melamine-formaldehyde resin prepolymers and urea-formaldehyde resin prepolymers. A crosslinking agent for salts of alginic acid may be selected from, but not limited to, calcium salts and barium salts.

In embodiments of the invention where there are at least two water soluble polymers in the composition, when a crosslinking agent is present, it may selectively crosslink with one of the two polymers. Of course, in embodiments of the invention when there are more than two polymers (e.g. 3, 4, 5, 6, 7, 8, 9, 10, etc), it will be appreciated that the crosslinking agent may crosslink with more than one polymer, or that there may be more than one crosslinking agent present that may selectively crosslink some of the polymers present, while leaving at least one polymer uncrosslinked. In particular embodiments of the invention that may be mentioned herein, the polymer to be crosslinked (i.e. from the list of first polymers mentioned hereinbefore) may be polyvinyl alcohol and the crosslinking agent may be sodium tetraborate and/or ammonium zirconium carbonate.

In any embodiments of the invention, the crosslinking agent may be present in an amount of from 0.1 to 10.0 wt %. For example, the crosslinking agent may be present in an amount of from 0.3 to 6.0 wt %, such as from 0.4 to 5.0 wt % (e.g. from 0.4 to 4.6 wt %, such as from 0.8 to 4.0 wt %).

The active ingredient may be selected according to the insect and/or vegetation that is to be targeted. While any active agent that targets insects and/or vegetation may be used, non-limiting examples include biocides, insect pheromones, juvenile hormones, fertilizers, seed germination stimulants, plant growth regulators and combinations thereof. Biocides that may be mentioned herein include pesticides, which may in turn include herbicides, insecticides, insect growth regulators, nematicides, termiticides, molluscicides, piscicides, avicides, rodenticides, predacides, bactericides, microbicide, spermicides, algicides, nematicides, molluscicides, schistosomacides, larvicides, adulticides, insect repellents, animal repellents, antimicrobials, fungicides, disinfectants (antimicrobial), sanitizers and combinations thereof). Particular pesticides that may be mentioned herein include, but are not limited to, Bacillus thuringiensis serotype israelensis, O,O,O′,O′-tetramethyl-O,O′-sulfanediylbis(1,4-phenylene) diphosphorothioate, and alkyldimethylbenzylammonium chlorides.

It will be appreciated that the amount of the active agent present in the composition will be determined by the amount needed to ensure an effective concentration of said active agent in the body of water to be treated, while controlling the overall cost of the composition. With this in mind, when a potent active agent is used (e.g. a chemical), the amount needed within the composition may be lower, while when a less potent active agent is used (e.g. a bacteria) more of the active agent may be needed within the composition in order to achieve the desired effect. Thus, in embodiments of the invention where a potent active agent is used, the at least one active agent may be present in an amount of from 0.5 to 1.5 wt % (e.g. 0.5 to 1.0 wt %), while in embodiments of the invention where a less potent active agent is used the at least one active agent may be present in an amount of from 7.5 to 9.3 wt %. When used herein the terms “potent” and “less potent” are used with regard to their relative meanings and do not reflect a lack of activity in the active agent used. For example, it will be appreciated that a composition using a whole organism to achieve the desired effect (e.g. a bacteria) requires a higher proportion of active agent to achieve a similar effect as a formulation prepared using a chemical substance.

For example, mosquitoes are known to cause the spread of serious infectious diseases, and they tend to prefer warmer tropical climates and areas with a lot of stagnant water. Therefore, there is a need for the eradication of mosquito larvae in stagnant water to prevent the spread of diseases such as dengue fever and malaria, which can be transmitted by mosquitoes. In order for the composition of the invention to be effective, the composition is preferably distributed on the surface of a body of water in a fashion that enables the delivery of the active ingredients (e.g. a mosquito larvicide(s)), directly into the portion of water where the mosquito larvae are found (i.e. the surface of the water body).

In order to ensure that the formulation provides its desired controlled-release effect over its entire lifespan until complete dissolution, the active agents may be homogeneously dispersed throughout the composition, such that they are homogeneously dispersed throughout the water soluble polymer. As such, the release of the active agent(s) into the water may be directly proportional to the dissolution of the water soluble polymer.

A surfactant is present in the composition and may be selected from one or more of amphoteric or, more particularly, non-ionic and ionic surfactants. Particular surfactants that may be mentioned herein include, but are not limited to silicon surfactants, fluorosurfactants and polymeric surfactants.

Non-ionic surfactants that may be mentioned herein include, but are not limited to, ethoxylated linear alcohols, ethoxylated alkyl phenols, fatty acid esters, fatty alcohol polyglycosides, alkylpolyglucosides ethleneoxide/propyleneoxide copolymers, polyalcohols, ethoxylated polyalcohols, thiols (mercaptans), amides, alkylpolyglucosides and combinations thereof. Particular non-ionic surfactants that may be mentioned herein include, but are not limited to, tridecanol, 2° alcohol ethoxylate, ter-octyl-phenol, nonylphenol ethoxylate, abietic acid, 1,4-sorbitan, 2,5-sorbitan, 1,5-sorbitan, 1,4,3,6-isosorbitan, di-acyl ethoxy urea, ethoxylated imide, and ter-dodecyl mercaptan. In particular embodiments of the invention that may be mentioned herein, when a non-ionic surfactant is present in the composition it may be selected from one or more of the group consisting of ethoxylated alkyl phenols and fatty alcohol polyglycosides.

Ionic surfactants include amphoteric, anionic (e.g., but not limited to, ammonium lauryl sulfate, sodium lauryl sulfate, and/or carboxylates such as sodium stearate and sodium lauroyl sarcosinate) and cationic surfactants. In particular embodiments of the invention, cationic surfactants may be preferred. Suitable cationic surfactants include, but are not limited to benzalkonium chloride, benzethonium chloride, 5-bromo-5-nitro-1,3-dioxane, cetrimonium bromide, cetrimonium chloride, distearyldimethylammonium chloride, lauryl methyl gluceth-10 hydroxypropyl dimonium chloride, octenidine dihydrochloride, olaflur, tetramethylammonium hydroxide, and combinations thereof.

In embodiments of the invention, and without wishing to be bound by theory, when a cationic surfactant is present, it may also act as a flotation agent within the composition. That is, the cationic surfactant may enhance the buoyancy of the composition. However, as is detailed below, it is not always necessary for a cationic surfactant to be present in the compositions of the current invention in order for a suitable flotation to be obtained and maintained (e.g. see composition 18). Particular cationic surfactants that may be mentioned herein that may also act as a flotation agent include dodecylamine acetate, dodecylamine hydrochloride, dodecyltrimethylammonium hydrochloride, benzalkonium chloride, cetrimonium bromide and combinations thereof.

As will be noted, in certain embodiments of the invention, certain amphoteric, non-ionic and ionic surfactants may also act as active agents (e.g. alkyldimethylbenzylammonium chlorides), and so may be referred to as multi-action compounds. In certain embodiments of the invention, the surfactant may double as both active agent and surfactant. In alternative, and more particular, embodiments of the invention, when a percentage value is used for the active agent and the surfactant, how the multi-action compound is considered will depend on the context of that composition. For example, in embodiments of the invention, the active agent may be present in an amount of from 6.0 to 9.5 wt % and the surfactant may be present in an amount of from 11.0 to 22.0 wt %. In certain embodiments of the invention, it is possible for the multi-action compound to be considered to contribute to both the totals for the active agent and the surfactant (e.g. a composition comprising 8 wt % of a quaternary benzalkonium chloride (and no other active agent) and 3 wt % of a non-active non-ionic surfactant—in this case, the quaternary benzalkonium chloride counts as both the active ingredient and as part of the surfactant to the weight percentage totals). In other, and more particular, embodiments of the invention, the total amounts of active agent and surfactant may be entirely separate. In such embodiments, the multi-action compound is only counted as a surfactant or only as an active agent depending on the context of the formulation. For example, in a composition where there is 9.5 wt % of an active agent that is not also a surfactant, the multi-action compound is treated as adding to the total of the surfactant. Alternatively, in a composition where there is 22 wt % of a non-multi-action compound as surfactant, 4 wt % of a multi-action compound and 3 wt % of a non-multi-action compound as active agent present in the composition, then the multi-action compound is counted as part of the active agent total.

When a combination of amphoteric and/or non-ionic and/or ionic surfactants are present, then the total amount of the surfactant is taken as being 100 wt % by weight of the surfactant (and not the entire composition). For example, in a composition comprising non-ionic and ionic surfactants, the non-ionic surfactants may be present in an amount from 54.5 wt % to 92.3 wt % and the ionic surfactants may be present in an amount from 7.7 wt % to 45.5 wt % (e.g. non-ionic surfactants may be present in an amount from 60 wt % to 85 wt % and the ionic surfactants may be present in an amount from 15 wt % to 40 wt %).

When present in the composition, and when acting as a flotation agent, the cationic surfactants may be present in an amount of from 1.0 wt % to 21.6 wt % of the total composition. For example, when the floatation agent is dodecylamine acetate and/or dodecylamine hydrochloride, the flotation agent may be present in an amount of from 4.7 wt % to 4.9 wt % of the total composition and when the floatation agent is a quaternary benzalkonium chloride it may be present in an amount from 1 wt % to 22.2 wt % of the total composition. It will be appreciated that when the flotation agent is a multi-action compound (i.e. a surfactant and active agent), the considerations immediately above also apply.

The composition of the invention also comprises a binder. The binder may be a mono-alkoxyalcohol, or more particularly, a dialkoxyalcohol, a trialkoxyalcohol, a poly-alkoxyalcohol, water or mixtures thereof. In particular embodiments of the invention, the binder may be selected from one or more of the group consisting of ethanol, water, and glycerol. Without wishing to be bound by theory, the binder may help to bind the polymer together into a solid, malleable mass that can be processed into various desired shapes according the desired dosage form of the composition. In addition, the binder may also function as a mediator for controlling the malleability of the polymer matrix, allowing for the room temperature, low pressure processing of the matrix and also for making the composition in a variety of forms. The degree of malleability of the polymer matrix may affected by the percentage of binder within the polymer matrix. The higher the percentage of binder, the more malleable the matrix may become. It will be appreciated that the selection of the binder may depend, in part, on the active agent that is to be used. For example, while water may be used as a binder, it may not be suitable for use with an active agent that is water sensitive (e.g. Bacillus thuringiensis serotype israelensis), in which case the use of a non-aqueous binder may be preferred (e.g. glycerol). A suitable amount of binder in embodiments of the invention may be from 22.7 to 35.0 wt % (e.g. 23.0 to 30.0 wt %) of the composition.

As noted hereinbefore, the composition may further comprise one or more additives or excipients. Such additives and excipients include materials such as a release agent, a colourant, a preservative, a sunscreen agent, or a buffering agent.

A release agent may enable the formulation to be released from a mould or for the formulation to be more easily processed during production (e.g. easier extrusion of the composition from an extruder). Suitable release agents include, but are not limited to oils (e.g. mineral oil) and may be present in an amount of from 0.5 to 5 wt % (e.g. from 1.0 to 2 wt %).

A colorant may provide a defined colour to the composition to make it easier to spot in the water body and make it easier to work out when a new dose of the composition may be needed. Such colourants may be any suitable colour, but a yellow or orange dye may be particularly suitable as it stands out from the colour of the surrounding body of water and vegetation. Colourants may be present in the composition in an amount of from 0.05 to 0.5 wt % (e.g. from 0.1 to 0.2 wt %).

The terms “sunscreen agents” refers to compounds that partially block or screen UV radiation by absorbing UV radiation (such as oxybenzone) or reflecting UV rays (such as titanium dioxide, zinc oxide), or a combination thereof. The above terms are meant to encompass all groups of sunscreens, including, but not limited to, UVA sunscreens, which block UV radiation in the wavelength range of about 320 to 400 nm, UVB sunscreens, which block radiation in the range of 290 to 320 nm, and the broad spectrum agents which block all ranges. Non-limiting examples of such agents include TiO₂, avobenzone, p-aminobenzoic acid, bemotrizinol, benzophenone-9, bexophenome-3, bisoctrizole, 3-(4-methylbenzylidene)-camphor, cinoxate, diethylamino hydroxybenzoyl hexyl benzoate, dioxybenzone, drometrizole trisiloxane, ecamsule, ethylhexyl triazone, homosalate, menthyl anthranilate, octocrylene, octyl salicylate, iscotrizinol, isopentenyl-4-methoxycinnamate, octyl-dimethyl-p-aminobenzoic acid, octyl-methoxycinnamate, oxybenzone, polysilicone-15, trolamine salicylate, ZnO, and any combination thereof.

As the composition may be stored for a period of time before use, it is important to make sure that the composition remains stable before use. This is particularly important where the active agent may otherwise be subject to degradation over time (e.g. Bacillus thuringiensis serotype israelensis). As such a preservative may be used to stablisise the composition for storage in certain embodiments. A suitable preservative that may be mentioned herein is citric acid. Preservatives may be present in the composition in an amount of from 1.9 wt % to 4.8 wt %. Without wishing to be bound by theory, it is believed that citric acid may also act as a buffering agent to generate a local pH around the composition that may enhance the effectiveness of certain floatation agents that may be pH sensitive. As such, the composition may also benefit from the introduction of a buffer agent in certain embodiments.

In further embodiments of the composition:

(a) the water-soluble polymer may be present in an amount of from 35.0 to 60.0 wt %, such as from 38.0 to 59.5 wt %, such as from 45.0 to 59.5 wt %, such as from 49.0 to 59.5 wt %;
(b) the at least one active agent may be present in an amount of from 0.1 to 50.0, such as from 6.0 to 15.0 wt %, from 6.0 to 9.5 wt % (e.g. from 7.5 to 9.3 wt %), or such as from 0.3 to 2.5 wt %, from 0.4 to 2.0 wt %, such as from 0.5 to 1.5 wt % or from 0.5 to 1.0 wt %;
(c) the at least one surfactant may be present in an amount of from 5.0 to 35.0 wt %, such as from 6.0 to 30 wt %, from 7.5 to 22.0 wt %, or from 11.0 to 22.0 wt %;
(d) the binder may be present in an amount of from 10.0 to 50.0 wt %, such as from 10.0 to 40 wt %, from 22.7 to 40.0 wt %, from 22.7 to 35.0 wt %, from 22.7 to 30.0 wt %, or from 23.0 to 30.0 wt %. It will be appreciated that the above embodiments may be combined in any technically sensible combination with the first aspect of the invention or together.

In embodiments related to those immediately above, there may also be provided the following additional components:

(i) a crosslinking agent that may be present in an amount of from 0.1 to 10.0 wt %, such as from 0.3 to 6.0 wt %, such as from 0.4 to 5.0 wt % (e.g. from 0.4 to 4.6 wt %, such as from 0.8 to 4.0 wt %);
(ii) a floatation agent (as part or whole of the surfactant), which flotation agent may be present in an amount of from 1.0 wt % to 21.6 wt % of the total composition, such as from 4.7 wt % to 4.9 wt %, for example 1.0 to 22.2 wt %;
(iii) a release agent, which may be present in an amount of from 0.5 to 5 wt % (e.g. from 1.0 to 2 wt %);
(iv) a colourant, which may be present in the composition in an amount of from 0.05 to 0.5 wt % (e.g. from 0.1 to 0.2 wt %);
(v) a preservative, which may be present in the composition in an amount of from 1.9 wt % to 4.8 wt %. It will be appreciated that the above additional components may be combined with the first aspect of the invention or with any technically sensible combination of the embodiments (a) to (d) above or with any technically sensible combination of (i) to (v) themselves.

To prepare the composition of the invention, the essential ingredients may be mixed together and blended at room temperature to form a homogenous mixture that may initially be a soft, malleable mass. The use of room-temperature blending not only ensures that any heat-sensitive ingredients are not degraded, but also ensures the integrity of the active ingredient whose properties may be damaged or changed at elevated temperatures required in other processes. Due to the malleability of the initial composition, it may be extruded at a low pressure that allows a significant amount of liquid ingredients, for instance the desirable liquid active ingredient, to be incorporated in the composition. For example, the initial composition may be extruded at a low pressure of about 5 psi to about 50 psi. If the matrix is subject to a high pressure, the liquid ingredients may be squeezed out from the matrix during the extrusion phase. Therefore, the low pressure processing in the extruder according to the invention ensures that the active agent is not removed during processing of the composition. Such a method may involve:
(a) providing a blended mixture comprising:
   a water-soluble polymer;
   at least one active agent;
   at least one surfactant; and
   a binder; and
(b) extruding the blended mixture to form an extrudate.

After the soft and malleable mass is extruded, the extrudate is cut into segments which are then machined into different shapes and sizes, depending on the intended use and release profile. For example the composition may be made into the form of tablets, pellets, blocks, cylinders, granulated particles, or the like. In certain embodiments, before the extrudate is formed into possible dosage forms, the extruded material may be added back into an extruder and subjected to from one to five further rounds of extrusion. This additional extrusion may help to ensure that the active agent is completely homogeneously distributed throughout the composition.

When a crosslinker is present in the composition, after the composition is machined in its final shape, it may be left in an ambient space for about a few hours to enable the in-situ crosslinking of the water-soluble polymer to be completed before use and/or further processing (e.g. packaging etc). Without wishing to be bound by theory, the crosslinking may increase the molecular weight of the polymer and therefore reduce the dissolution rate of the polymer, leading to a more controlled release of the active agent.

Without wishing to be bound by theory, it is believed that the presence of the binder and surfactant may generate air pockets, which are entrapped and distributed homogeneously throughout the composition. The air pockets may lower the density of the composition leading to its floatation. By varying the amount of the surfactant used, the blending time and the blending speed of the ingredients, the amount of air pockets in the matrix can be adjusted, leading to the desirable density of the composition. In this way, the floatability of the composition and thus the floatation of the composition at different water depths may be controlled, or even a non-floatable composition may be obtained when necessary. As noted hereinbefore, the length of time that the composition is buoyant for may be until the composition has fully dissolved, or for a period of time until water has sufficiently ingressed into the remaining block of the composition that it results in the block sinking to the bottom of the body of water in which it has been placed. When the block is designed to sink after a period of buoyancy, the period of buoyancy before the composition sinks may be at least 2 seconds, such as at least 10 seconds, such as at least 30 seconds, such as at least 1 minute, such as at least 10 minutes, such as at least 30 minutes, such as at least 1 hour or, more particularly, such as at least 4 hours (e.g. at least 5 hours), such as at least 6 hours or at least 24 hours (e.g. from 24 to 336 hours). It will be appreciated that composition blocks that are designed to sink, the composition retains some buoyancy for at most 70% of the time period between placement in a body of water (i.e. immersion) and full dissolution (e.g. the composition may be buoyant for less than 60%, such as 50%, such as 33% of the entire time period between immersion and full dissolution). Compositions that are designed to float until full dissolution may also sink after a period of time, but in this case the composition retains some buoyancy for at least 80% of the period until full dissolution (e.g. greater than 87%, such as greater than 90% of the entire time period between immersion and full dissolution).

Embodiments of the invention where the composition is designed to sink after a period of time may be accomplished through the use of the same polymer, but with differing viscosity and solubility (or replacing a polymer with another where these properties are varied). For example, while one grade of polyvinyl alcohol (e.g. a polyvinyl alcohol having a viscosity of about 55 CPS) is used in a composition described herein that is designed to float for the full time until dissolution (as defined above), it may be possible to change the composition into one that sinks more quickly by replacing this grade of polyvinyl alcohol with a different grade that has a lower viscosity and/or a higher water solubility (e.g. a viscosity of around 25 CPS). In alternative or additional embodiments of the invention, the amount of surfactant may be varied to provide a composition block that is designed to sink after a period of time. For example, reducing the amount of surfactant in a composition block that has been designed to float for the full period of time (e.g. one of Compositions 2, 3, 5 to 7, 11, 20, 21 and 23 below) until dissolution may result in a composition block that will sink in at most 70% of the entire time period between immersion and full dissolution (provided that the composition floats for a minimum period of time, such as at least 2 seconds, such as at least 10 seconds, such as at least 30 seconds, such as at least 1 minute, such as at least 10 minutes, such as at least 30 minutes, such as at least 1 hour or, more particularly, such as at least 4 hours (e.g. at least 5 hours), such as at least 6 hours or at least 24 hours (e.g. from 24 to 336 hours)). In yet further alternative or additional embodiments, the degree of foaming of the surfactant may also affect the ability of the composition to maintain its buoyancy, whereby using a surfactant having reduced foaminess (or replacing a cationic surfactant with an anionic or nonionic surfactant) may result in in a composition block that will sink in at most 70% of the entire time period between immersion and full dissolution.

The invention thus provides a controlled release composition for continuous eradication or control of pests and/or vegetation which are characterized by:
full water solubility;
different degrees of floatability so that floatation at different water depths is achievable;
being made using low pressures, so that high levels of liquid active ingredients are contained in the composition; and
being made at room temperature hence the active ingredient is not subject to deterioration at elevated temperature.

The room temperature and low pressure processing simplifies the manufacture of the composition at low cost. By controlling the amount of the crosslinking agent to modify the dissolution profile of the composition, the release of the active ingredient may be controlled to take place over at least 30 days.

While the embodiments described herein are intended as an exemplary controlled release composition for eradicating or controlling pests and/or vegetation, it will be appreciated by those skilled in the art that the present invention is not limited to the embodiments illustrated. Those skilled in the art will envision many other possible variations and modifications by means of the skilled person's common knowledge without departing from the scope of the invention, however, such variations and modifications should fall into the scope of this invention.

### EXAMPLES

In the compositions provided below, the weights listed relate to the commercial ingredients as added to the composition. Thus, when 100 g are provided of an ingredient like ammonium zirconium carbonate is listed in a composition, which is unstable in dry form and is provided as an approximately 25 wt % mixture in water, 25 g of the ingredient is ammonium zirconium carbonate and the remaining 75 g is water (which is counted as part of the binder when calculating the weight percentage of binder present in the composition).

### Composition 1

| Composition | Weight (g) |
|---|---|
| Polyvinylalcohol | 1080 |
| Hydroxypropylmethylcellulose | 67.5 |
| Alkylbenzyldimethylammonium | 480 |
| chloride (80 wt %), EtOH (20 | |
| wt %) | |
| Water | 525 |
| Ammonium zirconium | 100 |
| carbonate (approx. 25 wt % | |
| ammonium zirconium | |
| carbonate; approx. 75 wt % | |
| water) | |
| O,O,O′,O′-tetramethyl-O,O′- | 25 |
| sulfanediylbis(1,4-phenylene) | |
| diphosphorothioate (50 wt % | |
| active; 42 wt % organic | |
| solvent; 6 wt % emulsifier; and | |
| 2 wt % soyabean oil) | |
| Lemon Yellow Dye | 5 |
| Mineral Oil | 35 |

1. Polyvinylalcohol and hydroxypropylmethylcellulose were mixed together using an overhead stirrer set at 70 rpm for 3 minutes.
2. Alkylbenzyldimethylammonium chloride (80 wt %), EtOH (20 wt %) was added to the mixture of step 1 and the stirring was continued for a further 3 minutes.
3. Water, ammonium zirconium carbonate (approx. 25 wt % ammonium zirconium carbonate; approx. 75 wt % water), O,O,O′,O′-tetramethyl-O,O′-sulfanediylbis(1,4-phenylene) diphosphorothioate (50 wt % active; 42 wt % organic solvent; 6 wt % emulsifier; and 2 wt % soyabean oil) and lemon yellow dye were then added to the mixture and stirring was continued for a further 3 minutes.
4. Mineral oil was added to the mixture and the stirring continued for 30 seconds.
5. The mixture from step 4 was placed in a single screw extruder and was extruded from the machine.
6. The extruded material was placed back into the extruder and re-extruded.
7. Step 6 was repeated once and the resulting extruded material (having been extruded three times), was cut and shaped into a block weighing 15 g.

### Composition 2

| Composition | Weight (g) |
|---|---|
| Polyvinylalcohol | 900 |
| Hydroxypropylmethylcellulose | 250 |
| Nonylphenol ethyoxylate | 480 |
| Water | 525 |
| Ammonium zirconium | 100 |
| carbonate (approx. 25 wt % | |
| ammonium zirconium | |
| carbonate; approx. 75 wt % | |
| water) | |
| O,O,O′,O′-tetramethyl-O,O′- | 25 |
| sulfanediylbis(1,4-phenylene) | |
| diphosphorothioate (50 wt % | |
| active; 42 wt % organic | |
| solvent; 6 wt % emulsifier; and | |
| 2 wt % soyabean oil) | |
| Lemon Yellow Dye | 3 |
| Mineral Oil | 35 |

1. Polyvinylalcohol and hydroxypropylmethylcellulose were mixed together using an overhead stirrer set at 70 rpm for 3 minutes.
2. Nonylphenol ethoxylate was added to the mixture of step 1 and the stirring was continued for a further 3 minutes.
3. Water, ammonium zirconium carbonate (approx. 25 wt % ammonium zirconium carbonate; approx. 75 wt % water), O,O,O′,O′-tetramethyl-O,O′-sulfanediylbis(1,4-phenylene) diphosphorothioate (50 wt % active; 42 wt % organic solvent; 6 wt % emulsifier; and 2 wt % soyabean oil) and lemon yellow dye were then added to the mixture and stirring was continued for a further 6 minutes.
4. Mineral oil was added to the mixture and the stirring continued for 30 seconds.
5. The mixture from step 4 was placed in a single screw extruder and was extruded from the machine.
6. The extruded material was placed back into the extruder and re-extruded.
7. Step 6 was repeated once and the resulting extruded material (having been extruded three times), was cut and shaped into a block weighing 15 g.

### Composition 3

| Composition | Weight (g) |
|---|---|
| Polyvinylalcohol | 900 |
| Hydroxypropylmethylcellulose | 250 |
| Alkylbenzyldimethylammonium | 480 |
| chloride (80 wt %), EtOH (20 | |
| wt %) | |
| Water | 525 |
| Sodium Tetraborate | 90 |
| O,O,O′,O′-tetramethyl-O,O′- | 25 |
| sulfanediylbis(1,4-phenylene) | |
| diphosphorothioate (50 wt % | |
| active; 42 wt % organic | |
| solvent; 6 wt % emulsifier; and | |
| 2 wt % soyabean oil) | |
| Lemon Yellow Dye | 3 |
| Mineral Oil | 35 |

1. Polyvinylalcohol and hydroxypropylmethylcellulose were mixed together using an overhead stirrer set at 70 rpm for 3 minutes.
2. Alkylbenzyldime-thylammonium chloride (80 wt %), EtOH (20 wt %) was added to the mixture of step 1 and the stirring was continued for a further 3 minutes.
3. Water, sodium tetraborate, O,O,O′,O′-tetramethyl-O,O′-sulfanediylbis(1,4-phenylene) diphosphorothioate (50 wt % active; 42 wt % organic solvent; 6 wt % emulsifier; and 2 wt % soyabean oil) and lemon yellow dye were then added to the mixture and stirring was continued for a further 6 minutes.
4. Mineral oil was added to the mixture and the stirring continued for 30 seconds.
5. The mixture from step 4 was placed in a single screw extruder and was extruded from the machine.
6. The extruded material was placed back into the extruder and re-extruded.
7. Step 6 was repeated once and the resulting extruded material (having been extruded three times), was cut and shaped into a block weighing 15 g.

### Composition 4

| Composition | Weight (g) |
|---|---|
| Polyvinylalcohol | 900 |
| Hydroxypropylmethylcellulose | 250 |
| Alkylbenzyldimethylammonium | 480 |
| chloride (80 wt %), EtOH (20 | |
| wt %) | |
| Water | 525 |
| O,O,O′,O′-tetramethyl-O,O′- | 25 |
| sulfanediylbis(1,4-phenylene) | |
| diphosphorothioate (50 wt % | |
| active; 42 wt % organic | |
| solvent; 6 wt % emulsifier; and | |
| 2 wt % soyabean oil) | |
| Lemon Yellow Dye | 3 |
| Mineral Oil | 35 |
| Sodium Tetraborate | 9 |

1. Polyvinylalcohol and hydroxypropylmethylcellulose were mixed together using an overhead stirrer set at 70 rpm for 3 minutes.
2. Alkylbenzyldime-thylammonium chloride (80 wt %), EtOH (20 wt %) was added to the mixture of step 1 and the stirring was continued for a further 3 minutes.
3. Water, sodium tetraborate, O,O,O′,O′-tetramethyl-O,O′-sulfanediylbis(1,4-phenylene) diphosphorothioate (50 wt % active; 42 wt % organic solvent; 6 wt % emulsifier; and 2 wt % soyabean oil) and lemon yellow dye were then added to the mixture and stirring was continued for a further 6 minutes.
4. Mineral oil was added to the mixture and the stirring continued for 30 seconds.
5. Sodium tetraborate was added to the mixture and the stirring continued for 15 seconds.
6. The mixture from step 5 was placed in a single screw extruder and was extruded from the machine.
7. The extruded material was placed back into the extruder and re-extruded.
8. Step 7 was repeated once and the resulting extruded material (having been extruded three times), was cut and shaped into a block weighing 15 g.

### Composition 5

| Composition | Weight (g) |
|---|---|
| Polyvinylalcohol | 900 |
| Hydroxypropylmethylcellulose | 250 |
| Alkylbenzyldimethylammonium | 480 |
| chloride (80 wt %), EtOH (20 | |
| wt %) | |
| Water | 525 |
| O,O,O′,O′-tetramethyl-O,O′- | 25 |
| sulfanediylbis(1,4-phenylene) | |
| diphosphorothioate (50 wt % | |
| active; 42 wt % organic | |
| solvent; 6 wt % emulsifier; and | |
| 2 wt % soyabean oil) | |
| Lemon Yellow Dye | 3 |
| Mineral Oil | 35 |
| Sodium Tetraborate | 45 |

1. Polyvinylalcohol and hydroxypropylmethylcellulose were mixed together using an overhead stirrer set at 70 rpm for 3 minutes.
2. Alkylbenzyldime-thylammonium chloride (80 wt %), EtOH (20 wt %) was added to the mixture of step 1 and the stirring was continued for a further 3 minutes.
3. Water, sodium tetraborate, O,O,O′,O′-tetramethyl-O,O′-sulfanediylbis(1,4-phenylene) diphosphorothioate (50 wt % active; 42 wt % organic solvent; 6 wt % emulsifier; and 2 wt % soyabean oil) and lemon yellow dye were then added to the mixture and stirring was continued for a further 6 minutes.
4. Mineral oil was added to the mixture and the stirring continued for 30 seconds.
5. Sodium tetraborate was added to the mixture and the stirring continued for 30 seconds.
6. The mixture from step 5 was placed in a single screw extruder and was extruded from the machine.
7. The extruded material was placed back into the extruder and re-extruded.
8. Step 7 was repeated once and the resulting extruded material (having been extruded three times), was cut and shaped into a block weighing 15 g.

### Composition 6

The procedure of Composition 5 was followed, except that the extruded material of step 8 was formed into a block weighing 30 g.

### Compositions 7 to 28

Further compositions were formulated according to the ingredients and amounts provided in Tables 1 to 4 below.

General Procedure
1. The polymer(s) and active ingredient(s) are mixed together until they are homogeneous.
2. The flotation collector and optionally the surfactant are added to the mixture of step 1 and mixed together until they are homogeneous.
3. The binder and other water soluble additives such as the lemon yellow dye, citric acid and any other water soluble or emulsifiable active ingredient but not the crosslinking agent are mixed together to form a premixture. The premixture is then added to the mixture of step 2 and mixed together until they are homogeneous.
4. Mineral oil is added to the mixture of step 3 and mixed.
5. The crosslinking agent is added to the mixture of step 4 and mixed further.

TABLE 1

| | Composition Number | | | | |
|---|---|---|---|---|---|
| Compound/wt (g) | 7 | 8 | 9 | 10 | 11 |
| Polyvinylalcohol | 1150 | 450 | 287.5 | 345 | 450 |
| Hydroxypropylmethylcellulose | 100 | 125 | 287.5 | 230 | 125 |
| H₂O | 525 | 262.5 | 262.5 | 262.5 | |
| Lemon Yellow Dye | 3 | 1.5 | 1.5 | 1.5 | |
| Mineral Oil | 35 | 17.5 | 17.5 | 17.5 | 17.5 |
| O,O,O′,O′-tetramethyl-O,O′- | 25 | 12.5 | 12.5 | 12.5 | |
| sulfanediylbis(1,4-phenylene) | | | | | |
| diphosphorothiolate | | | | | |
| (50 wt % active; 42 wt % | | | | | |
| organic solvent; 6 wt % | | | | | |
| emulsifier; and 2 wt % | | | | | |
| soyabean oil) | | | | | |
| Bacillus thuringiensis | | | | | 100 |
| Israeiensis (BTI) | | | | | |
| 2° Alcohol Ethoxylate | 240 | | | | |
| Alkyl polyglucoside (70 wt %); | | 120 | 120 | 120 | 120 |
| water (30 wt %) | | | | | |
| Sodium tetraborate | 30 | 10 | 10 | 10 | 10 |
| Glycerin | | | | | 263 |

TABLE 2

| | Composition Number | | | | |
|---|---|---|---|---|---|
| Compound/wt (g) | 12 | 13 | 14 | 15 | 16 |
| Polyvinylalcohol | 900 | 900 | 900 | 900 | 900 |
| Hydroxypropylmethylcellulose | 250 | 250 | 250 | 250 | 250 |
| H₂O | 525 | 525 | 525 | 525 | 525 |
| Lemon Yellow Dye | 3 | 3 | 3 | 3 | 3 |
| Mineral Oil | 35 | 35 | 35 | 35 | 35 |
| O,O,O′,O′-tetramethyl-O,O′- | 25 | 25 | 25 | 25 | 25 |
| sulfanediylbis(1,4-phenylene) | | | | | |
| diphosphorothiolate | | | | | |
| (50 wt % active; 42 wt % | | | | | |
| organic solvent; 6 wt % | | | | | |
| emulsifier; and 2 wt % | | | | | |
| soyabean oil) | | | | | |
| 2° Alcohol Ethoxylate | 240 | 240 | 240 | 240 | 240 |
| Sodium tetraborate | 45 | 20 | 30 | 30 | 20 |

TABLE 3

| | Composition Number | | | | | |
|---|---|---|---|---|---|---|
| Compound/wt (g) | 17 | 18 | 19 | 20 | 21 | 22 |
| Polyvinylalcohol | 450 | 450 | 450 | 450 | 450 | 450 |
| Hydroxypropylmethylcellulose | 125 | 125 | 125 | 125 | 125 | 125 |
| H₂O | 262.5 | 262.5 | 250 | 250 | 250 | 250 |
| Yellow Dye | 1.5 | 1.5 | 1.5 | 1.5 | 1.5 | 1.5 |
| Mineral Oil | 17.5 | 17.5 | 17.5 | 17.5 | 17.5 | 17.5 |
| O,O,O′,O′-tetramethyl-O,O′- | 12.5 | 12.5 | 12.5 | 12.5 | 12.5 | 12.5 |
| sulfanediylbis (1,4-phenylene) | | | | | | |
| diphosphorothiolate | | | | | | |
| (50 wt % active; 42 wt % organic | | | | | | |
| solvent; 6 wt % emulsifier; and 2 | | | | | | |
| wt % soyabean oil) | | | | | | |
| Alkylbenzyldime-thylammonium | | | 10 | 50 | 100 | |
| chloride (80 wt %), EtOH (20 | | | | | | |
| wt %) | | | | | | |
| Alkyl polyglucoside (70 wt %), | 120 | 240 | 120 | 120 | 120 | 120 |
| water (30 wt %) | | | | | | |
| Citric Acid | 50 | | | | | 20 |
| Dodecylamine acetate | | | | | | |
| Dodecylamine hydrochloride | | | | | | 50 |
| Sodium tetraborate | 10 | 45 | 10 | 10 | 10 | 10 |

TABLE 4

| | Composition Number | | | | | |
|---|---|---|---|---|---|---|
| Compound/wt (g) | 23 | 24 | 25 | 26 | 27 | 28 |
| Polyvinylalcohol | 900 | 1150 | 903 | 700 | 450 | 450 |
| Hydroxypropylmethylcellulose | 250 | — | 277 | 700 | 125 | 125 |
| H₂O | 525 | 400 | 878 | 525 | 262.5 | 262.5 |
| Yellow Dye | 3 | 3 | 1 | 3 | 1.5 | 1.5 |
| Mineral Oil | 35 | 55 | 23 | 45 | 17.5 | 17.5 |
| O,O,O′,O′-tetramethyl-O,O′- | 25 | 25 | 139 | 25 | 12.5 | 12.5 |
| sulfanediylbis(1,4-phenylene) | | | | | | |
| diphosphorothiolate | | | | | | |
| (50 wt % active; 42 wt % organic | | | | | | |
| solvent; 6 wt % emulsifier; and 2 | | | | | | |
| wt % soyabean oil) | | | | | | |
| Alkylbenzyldime-thylammonium | 480 | 480 | 5 | 480 | | |
| chloride (80 wt %), EtOH (20 | | | | | | |
| wt %) | | | | | | |
| Alkyl polyglucoside (70 wt %), | | | | | 120 | 240 |
| water (30 wt %) | | | | | | |
| Citric Acid | | | | | 25 | |
| Dodecylamine acetate | | | | | | |
| Dodecylamine hydrochloride | | | | | | |
| Sodium tetraborate | | 45 | | 45 | 10 | 22.5 |

### Example 1

All compositions were placed in a body of water to test for buoyancy by suspending them in a net sufficiently long to allow the composition to sink over a body of water (i.e. a bucket) with a wooden spoon.

### General Procedure

1. A 5 L tank was filled with 5 L of water and maintained at around 24° C. to 30° C.
2. Netting (32.5 cm in length) was tightened around a block of the compound (each block has the dimensions of 23 mm diameter×40 mm length and weighs 15 g). The netting was tightened around the block by folding and stapling the netting on one side.
3. The netting was secured with a closure hook and the block was suspended from a metal rod and submerged into the water at the centre of the tank.
4. Immediately after the block was applied to the tank the initial buoyancy result was recorded.
5. Results are then recorded every day until the block has dissolved or it sinks (for buoyant materials).

The results are provided in table 5 below.

TABLE 5

| | | No. of | No. Of |
|---|---|---|---|
| Composition | | Days | Days to full |
| No. | Buoyant? | Buoyant | dissolution |
| 1 | Yes | 7 | — |
| 2 | Yes | 9 | 10 |
| 3 | Yes | 9 | 9 |
| 4 | Yes | 5 | 8 |
| 5 | Yes | 15 | 16 |
| 6 | Yes | 22 | 22 |
| 7 | Yes | 5 | 5 |
| 8 | Yes | 5 | — |
| 9 | Yes | 8 | — |
| 10 | Yes | 6 | — |
| 11 | Yes | 7 | 8 |
| 12 | Yes | 5 | — |
| 13 | Yes | 3 | — |
| 14 | Yes | 6 | — |
| 15 | Yes | 5 | 15 |
| 16 | Yes | 6 | 11 |
| 17 | Semi floats | 12 | 19 |
| 18 | Yes | 7 | 14 |
| 19 | Yes | 8 | 21 |
| 20 | Yes | 24 | 25 |
| 21 | Yes | 13 | 14 |
| 22 | Yes | 14 | 25 |
| 23 | Yes | 10 | 11 |
| 24 | Yes | 3 | 4 |
| 25 | No | NA | 11 |
| 26 | Yes | 18 | 19 |
| 27 | Yes | 2 | 20 |
| 28 | Yes | 2 | 10 |

12* was performed on a 30g block scale.

The results above show that the crosslinker, the amount of HPMC (the second polymer) and the surfactant can all impact on the speed of dissolution of the blocks. In addition, the speed of release is affected by the matrix of formation and may further be affected by the size of the block. The size of the block also affects the time taken for complete dissolution. Without wishing to be bound by theory, it is believed that the inclusion of the surfactant enables to trapping of air into the composition, enabling the block to be buoyant. The amount of surfactant can be controlled so as to control the degree of buoyancy of the composition.

The most successful compositions described above relate to compositions where the number of buoyant days equals the number of days to full dissolution, when the composition is aimed at being a buoyant formulation throughout the lifetime of the composition. Without wishing to be bound by theory, it is believed that such formulations ensure that the composition effectively delivers the active agent to the required site of action over its entire lifespan, and therefore enables control of the pest throughout its deployment, thereby reducing waste. Particular formulas that may be considered to be the most successful of those described herein are, in no particular order, Compositions 5, 6, 20 and 21.

Compositions of the current invention that sink after a relatively short period of time may also be useful. Such compositions are represented by Compositions 4, 15 to 19, 22, 27 and 28. In particular Composition 17 is buoyant, but it does not float on the surface. Rather, Composition 17 retains a position of around 50% the depth of the water it is placed into for 12 days before sinking to the bottom of the body of water. As such, this composition shows that the compositions of the current invention may be used to target particular water depths through small manipulations of the composition.

1. A buoyant water-soluble controlled release composition for eradicating or controlling insects and/or vegetation in a body of water, comprising:
a water-soluble polymer;
at least one active agent;
at least one surfactant; and
a binder, wherein
the binder comprises at least one hydroxyl moiety.

2. The composition according to claim 1, wherein:
the water-soluble polymer is present in an amount of from 35.0 to 60.0 wt %;
the at least one active agent is present in an amount of from 0.1 to 50.0 wt %;
the at least one surfactant is present in an amount of from 5.0 to 35.0 wt %; and
the binder is present in an amount of from 10.0 to 50.0 wt %.

3. The composition according to claim 2, wherein:
the water-soluble polymer is present in an amount of from 38.0 to 59.5 wt % (e.g. from 45.0 to 59.5 wt %);
the at least one active agent is present in an amount of from 6.0 to 15.0 wt %;
the at least one surfactant is present in an amount of from 7.5 to 22.0 wt %;
the binder is present in an amount of from 22.7 to 40.0 wt %.

4. The composition according to claim 2, wherein:
the water-soluble polymer is present in an amount of from 38.0 to 59.5 wt % (e.g. from 45.0 to 59.5 wt %);
the at least one active agent is present in an amount of from 0.3 to 2.5 wt %;
the at least one surfactant is present in an amount of from 7.5 to 22.0 wt %;
the binder is present in an amount of from 22.7 to 40.0 wt %.

5. The composition according to claim 2, wherein:
the water-soluble polymer is present in an amount of from 35.0 to 45.2 wt %;
the at least one active agent is present in an amount of from 1.0 to 25.0 wt %, such as from 1.0 to 1.5 wt %;
the at least one surfactant is present in an amount of from 10.0 to 22.0 wt %; and
the binder is present in an amount of from 22.7 to 30.0 wt %, such as from 22.7 to 25.1 wt %.

6. The composition according to claim 1, wherein the water-soluble polymer is selected from one or more of the group consisting of carrageenan lambda, hyaluronic acid, pullulan, polyvinylpyrrolidone, polyacrylic acid, gum acaia, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, tragacanth, guar gum, polyacrylamide, and poly(2-ethyl-2-oxazoline), salts thereof and copolymers thereof.

7. The composition of claim 6, wherein the polymer water-soluble polymer comprises at least two polymers, where:
a first of the at least two polymers is selected from the group consisting of carrageenan lambda, hyaluronic acid, dextrans, pullulan, polyvinylpyrrolidone, polyvinyl alcohol, polyacrylic acid, polyethylene glycols, salts thereof and copolymers thereof;
a second of the at least two polymers is selected from the group consisting of gum acaia, gelatin, carboxymethylcellulose, microcrystalline cellulose, hydroxypropylmethylcellulose, ethylcellulose, methylcellulose, xanthan gum, maltodextrin, chitosan, carrageenan iota, carrageenan kappa, starch, pectins, salts of alginic acid, lignins, and salts thereof.

8. The composition of claim 7, wherein, when the total amount of polymer is taken as being 100 wt % by weight, the first polymer is present in an amount of from 40.0 wt % to 95.0 wt % and the second polymer is present in an amount of from 5.0 wt % to 60.0 wt %.

9. The composition according to claim 1, wherein the composition further comprises a crosslinking agent.

10. The composition according to claim 9, wherein the crosslinking agent is selected from one or more of the group consisting of sodium tetraborate, ammonium zirconium carbonate, sodium borate dialdehyde, melamine-formaldehyde, urea-formaldehyde, polyamide-epichlorohydrin, dimethylolurea, a polyfunctional azirdine, methoxymethylmelamine, a melamine-formaldehyde resin prepolymer, a urea-formaldehyde resin prepolymer, calcium salts, and barium salts.

11. (canceled)

12. The composition according to claim 10, wherein the crosslinking agent is present in an amount of from 0.3 to 6.0 wt %.

13. The composition according to claim 1, wherein the at least one active agent is present in an amount of from 0.5 to 1.5 wt %, or in an amount from 7.5 to 9.3 wt %.

14. (canceled)

15. The composition according to claim 1, wherein, the at least one active agent is selected from one or more of the group consisting of biocides, insect pheromones, juvenile hormones, fertilizers, seed germination stimulants, and plant growth regulators.

16. (canceled)

17. (canceled)

18. The composition according to claim 1, wherein the binder is selected from one or more of the group consisting of an mono-alkoxyalcohol, or more particularly, a dialkoxyalcohol, a trialkoxyalcohol, a poly-alkoxyalcohol and water.

19. The composition according to claim 1, wherein the surfactant is an ionic surfactant, an amphoteric surfactant, non-ionic surfactant or combinations thereof.

20. The composition according to claim 19, wherein:
(a) the non-ionic surfactant is selected from one or more of the group consisting of ethoxylated linear alcohols, ethoxylated alkyl phenols, fatty acid esters, fatty alcohol polyglycosides, alkylpolyglucosides ethleneoxide/propyleneoxide copolymers, polyalcohols, ethoxylated polyalcohols, thiols (mercaptans), amides and alkylpolyglucosides; and/or
(b) the ionic surfactant is a cationic surfactant.

21. The composition of claim 20, wherein the cationic surfactant is an ammonium-containing surfactant.

22. The composition according to claim 1, wherein:
(a) the composition is provided in a form that the composition fully dissolves into a body of water over a period of from 2 days to 100 days; and/or
(b) the composition comprises pockets of a gas (e.g. air) within the composition; and/or
(c) the composition is buoyant for a period of at least 4 hours following its placement into a body of water.

23. A method of preparing a buoyant water-soluble controlled release composition for eradicating or controlling insects and/or vegetation in a body of water according to claim 1, wherein the method comprises the steps of:
(a) providing a blended mixture comprising:
a water-soluble polymer;
at least one active agent;
at least one surfactant; and
a binder; and
(b) extruding the blended mixture to form an extrudate.

24. (canceled)

25. (canceled)

26. A method of eradicating or controlling insects and/or vegetation in a body of water, comprising placing the water-soluble controlled release composition according to claim 1 into the body of water.
